(19) United States
(12) Patent Application Publication
(10) Pub. No.: US 2026/0271825 A1
(43) Pub. Date: Sep. 17, 2026

(54) handheld spreader

(71) Applicant: SK & Y AGRICULTURAL EQUIPMENTS CO.,LTD., Fu Hsing Township (TW)

(72) Inventor: Jui-Chang Wu, Fu Hsing Township (TW)

(21) Appl. No.: 19/079,349

(22) Filed: Mar. 13, 2025

(51) Int. Cl. A01C 15/02

(52) U.S. Cl. CPC A01C 15/02

(57) ABSTRACT

A handheld spreader has a main body, a discharging switch and a locking unit. The main body has a storage space, a feeding opening connected to the storage space, a discharging opening and a handle. The discharging switch is combined with the opening and closing function of the locking unit, which not only frees the fingers from continuously pushing the toggle knob, making the structure more labor-saving to use, but also allows the locking unit to be displaced and positioned on the adjusting portion, further limiting the displacement path of the discharging switch, so as to adjust the material quantity.

### BACKGROUND OF THE INVENTION

### Field of Invention

The present invention relates to a handheld spreader, and more particularly to a handheld spreader.

### Description of the Related Art

The spreading of fertilizers is used to help the growth of crops and plants, and this operation is necessary in modern agriculture. There are various methods for spreading these pesticides or fertilizers, including spreading by hand without using any tools and using large-scale equipment equipped with a power source.

One of the spreading tools currently used in the above-mentioned spreading operation is to store the fertilizer to be spread in a material barrel of a backpack spreader, and then discharge the fertilizer from the connected channel between the material barrel and the discharge pipe for spreading operation. However, the backpack spreader needs to manually rotate the internal turntable or drive the turntable with an external motor to spray the fertilizer, so that the overall structure is more complicated and the assembly cost is increased. In addition, the fertilizer is usually powder or slightly moist material, which is easy to form balls or agglomerates, causing inconvenience in maintenance, repair and cleaning, resulting in increased operation time and lack of efficiency. There is indeed a need for improvement.

Therefore, it is desirable to provide a hammer to mitigate and/or obviate the aforementioned problems.

### SUMMARY OF THE INVENTION

An objective of present invention is to provide a handheld spreader, which is capable of improving the above-mention problems.

### SUMMARY OF THE DISCLOSURE

In order to achieve the above-mentioned objective, a handheld spreader has a main body, a discharging switch and a locking unit. The main body is formed from two symmetrical cases and comprises a storage space, a feed opening connected to the storage space, a discharge opening, and a handle, wherein the handle is arranged above the feed opening, and the handle further downwardly has an adjusting portion and a spring groove in sequence toward the discharge opening; a track is disposed at an inner top surface between the handle and the adjusting portion, and an open slot is disposed on an upper surface of the handle and connected to the track; a guiding slot is disposed and connected between an end of the track and the discharge opening; the adjusting portion is convex and hollow with a channel connected to the track, and a positioning slot is disposed on the adjusting portion and having a width smaller than a width of the channel. The discharging switch is disposed among the track, the guiding slot and the discharge opening, and is integrally formed to include an adjusting section, a positioning section, a spring section and a gate section in sequence; the adjusting section has a toggle knob and is limited in the open slot; the positioning section has a positioning column protruding out of the positioning slot; the spring section is provided with a raised plate with a protruding pillar facing the positioning column, and the protruding pillar is jacketed with a spring member and is arranged in the spring groove; the gate section is normally closed between the discharging opening and the storage space. The locking unit is installed on the adjusting portion and includes a locking screw rod, a switching panel, a locking nut and a fastening member; a slidable plate is formed at a bottom end of the locking screw rod and is slidably accommodated in the channel; the locking screw rod is positioned to pass through the positioning slot, a through aperture is disposed on one end of the switching panel through an upper and lower surfaces, the switching panel passes through the locking screw rod through the through aperture, and two shaft apertures are disposed on opposite sides of the switching panel; the locking nut and the locking screw rod are screwed together to further tighten the locking screw rod and the switching panel onto the positioning slot; the fastening member has two buckle arms, a convex shaft is mounted inside the two buckle arms and assembled to each of the shaft aperture on opposite sides of the switching panel, so that the fastening member is rotatably assembled on the switching panel; and the fastening member is further provided with a fastening hole between the two buckle arms, the fastening hole used to engage with the positioning column of the discharging switch.

Other objects, advantages, and novel features of invention will become more apparent from the following detailed description when taken in conjunction with the accompanying drawings.

### BRIEF DESCRIPTION OF THE DRAWINGS

FIG. 1 is a three-dimensional combination drawing of a preferred embodiment of the present invention.

FIG. 2 is an exploded view of the preferred embodiment of the present invention.

FIG. 3 is a cross-sectional and local enlarged drawing of the preferred embodiment of the present invention.

FIG. 4 is a cross-sectional view of the A-A section line shown in FIG. 3.

FIG. 5 is a schematic drawing of operating the discharging switch to the open state according to the preferred embodiment of the present invention.

FIG. 6 is a schematic drawing of the locking unit locking and fixing the discharging switch according to the preferred embodiment of the present invention.

FIG. 7 is a three-dimensional drawing of the discharging opening equipped with a discharging plate according to the preferred embodiment of the present invention.

FIG. 8 is a schematic drawing of the swinging of the main body to perform the spreading operation according to the preferred embodiment of the present invention.

FIG. 9 is a schematic drawing of the discharging opening equipped with an extension tube according to the preferred embodiment of the present invention.

FIG. 10 is a schematic drawing of the displacement and positioning of the locking unit along the adjustment part according to the preferred embodiment of the present invention.

### DETAILED DESCRIPTION OF PREFERRED EMBODIMENT

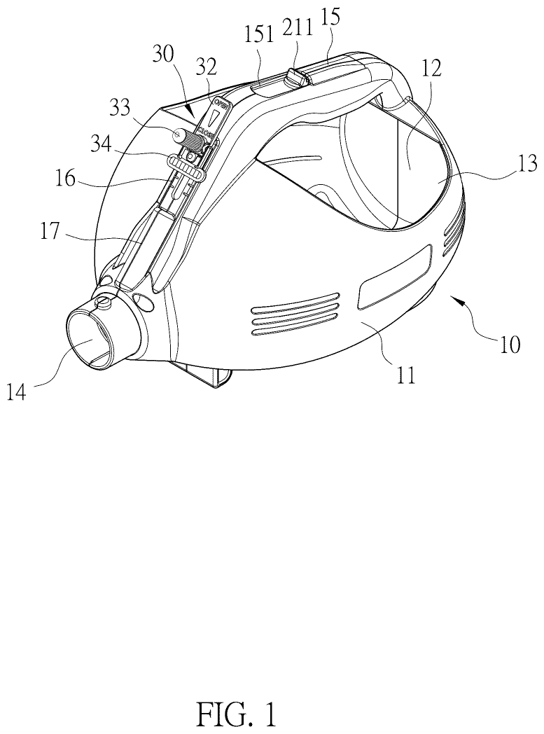

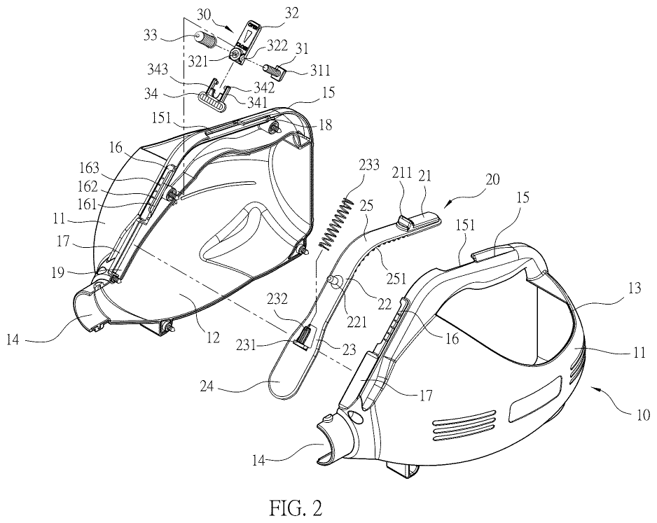

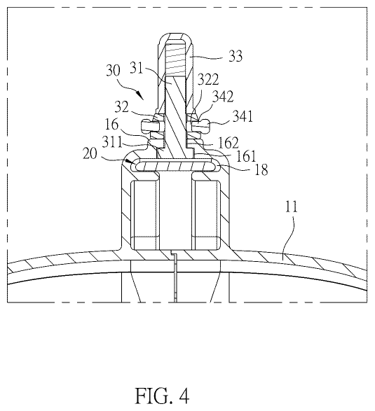

First, please refer to FIGS. 1-5, A handheld spreader comprises: a main body 10, a discharging switch 20 and a locking unit 30. The main body 10 is formed from two symmetrical cases 11 and has a storage space 12, a feeding opening 13 connected to the storage space 12, a discharging opening 14 and a handle 15. The handle 15 is arranged above the feeding opening 13, the handle further downwardly has an adjusting portion 16 and a spring groove 17 in sequence toward the discharging opening 14. A track 18 is disposed at an inner top surface between the handle 15 and the adjusting portion 16, and an open slot is disposed on an upper surface of the handle 15 and connected to the track 18. and connected to the track; a guiding slot 19 is disposed and connected between an end of the track 18 and the discharging opening 14. The adjusting portion 16 is convex and hollow with a channel 161 connected to the track 18, and a positioning slot 162 is disposed on the adjusting portion 16 and having a width smaller than a width of the channel 161. Furthermore, the upper surface of the adjusting portion 16 is provided with a plurality of scale marks 163 along both sides of the positioning slot 162.

Moreover, the discharging switch 20 is disposed among the track 18, the guiding slot 19 and the discharging opening 14, and is integrally formed to include an adjusting section 21, a positioning section 22, a spring section 23 and a gate section 24. The adjusting section 21 has a toggle knob 211 and is limited in the open slot 151. The positioning section 22 has a positioning column 221 protruding out of the positioning slot 162. The spring section 23 is provided with a raised plate 231 with a protruding pillar 221 facing the positioning column 231, and the protruding pillar 232 is jacketed with a spring member 233 and is arranged in the spring groove 17. The gate section 24 normally closed between the discharging opening 14 and the storage space.

Moreover, a curved section 25 is formed between the adjusting section 21 and the positioning section 22 of the discharging switch 20 to correspondingly match the track 8 to form a curved path between the handle 15 and the adjusting portion 16. Also, a bottom face of the curved section 25 has a plurality of parallel transverse grooves 251. In addition, an area of the gate section 24 of the discharging switch 20 is larger than an area of the spring section 23.

The locking unit 30 is installed on the adjusting portion 16 and includes a locking screw rod 31, a switching panel 32, a locking nut 33 and a fastening member 34. A slidable plate 311 is formed at a bottom end of the locking screw rod 31 rod and is slidably accommodated in the channel 161. The locking screw rod 31 rod is positioned to pass through the positioning slot 162, a through aperture 321 is disposed on one end of the switching panel 32 through an upper and lower surfaces, the switching panel 32 passes through the locking screw rod 31 through the through aperture 321, and two shaft apertures 322 are disposed on opposite sides of the switching panel 32. The locking nut 33 and the locking screw rod 31 are screwed together to further tighten the locking screw rod 31 and the switching panel 32 onto the positioning slot 162. The fastening member 34 has two buckle arms 341, a convex shaft 342 is respectively mounted inside the two buckle arms 341 and assembled to each of the shaft aperture 322 on opposite sides of the switching panel 32, so that the fastening member 34 is rotatably assembled on the switching pane 32. The fastening member 34 is further provided with a fastening hole 343 between the two buckle arms 341, and the fastening hole 343 is configured to engage with the positioning column 221 of the discharging switch 20.

The composition of the structure is shown in FIGS. 1 to 4. The discharging switch 20 is installed in the track 18 and the guiding slot 19 formed between the two cases 11. The adjusting section 21 of the discharging switch 20 is relatively accommodated in the track 18 of the handle 15, and the toggle knob 211 protrudes from the open slot 151, so that the displacement range of the toggle knob 211 is limited by the open slot 151 to achieve the purpose of switching. The positioning section 22 is relatively accommodated in the track 18 of the adjusting portion 16, and the positioning column 221 passes through the channel 161 and out of the positioning slot 162. The spring section 23 is relatively accommodated in the guiding slot 19 of the spring groove 17, the protruding pillar 232 is inserted into the spring member 233 accommodated in the spring groove 17, and the compression stroke of the spring member 233 is defined by the inner walls of the raised plate 231 and the spring groove 17. The gate section 24 is pushed through the discharging opening 14 by the spring member 233, thereby closing the discharging opening 14 and the channel 161 of the storage space 12. the slidable plate 311 of the locking unit 30 is first slidably assembled in the channel 161 of the adjusting portion 16, and the locking screw rod 31 protrudes out of the positioning slot 162. The switching panel 32 is placed through the locking screw rod 31 via the through aperture 321, and then the switching panel 32 is pressed and fixed onto the adjusting portion 16 by tightening the locking nut 33 onto the locking screw rod 31. Finally, the fastening member 34 is pivotally mounted on the shaft aperture 322 on both sides of the switching panel 32 through the convex shafts 342 on the inner sides of the two buckle arms 341, and the positioning column 221 of the discharging switch 20 is engaged and positioned through the fastening member 34, thereby completing a handheld discharging device structure.

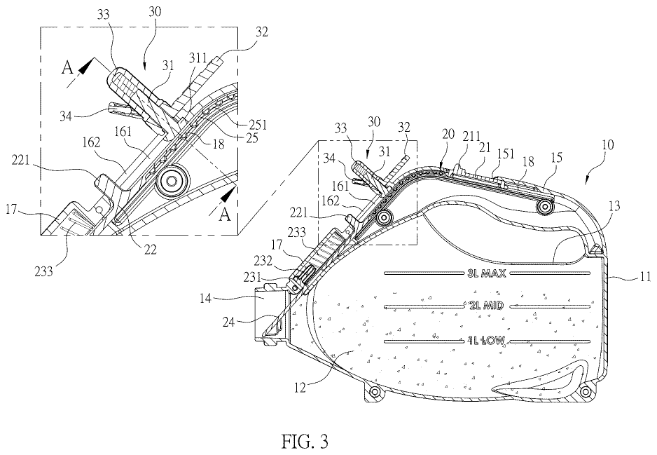

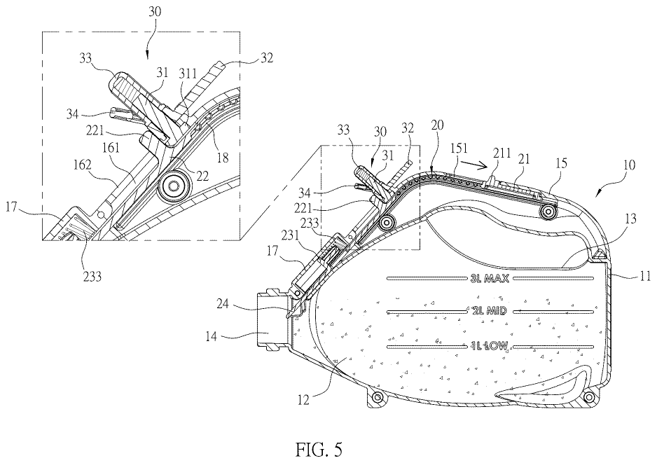

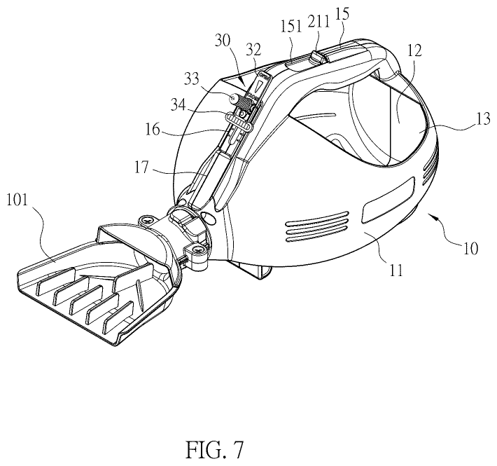

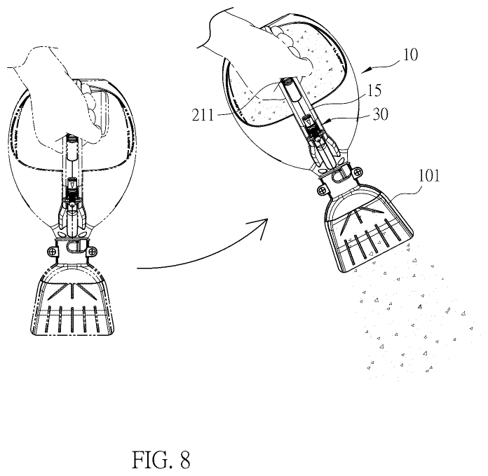

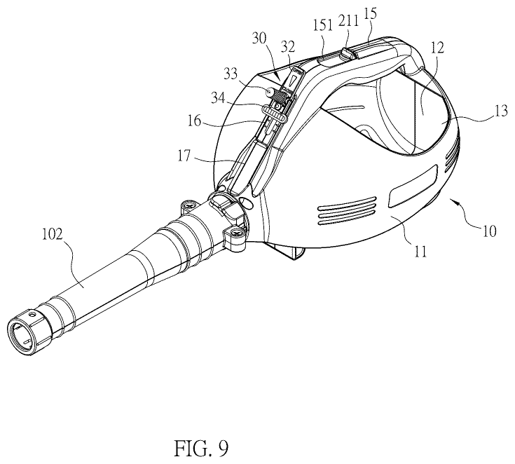

The actual usage of the structure is shown in FIG. 3. The storage space 12 is filled with various materials according to the working purpose, and the materials may be seeds, fertilizers, ice melts or sand. When the discharging switch 20 is not switched to open, the spring member 233 is in a stretched state and pushes the gate section 24 to be between the storage space 12 and the discharging opening 14 to form a closed state, further preventing the materials in the storage space 12 from leaking out. At the same time, the toggle knob 211 of the adjusting section 21 abuts against the front end of the open slot 151. When the material needs to be spread, as shown in FIG. 5, the user holds the handle 15 and moves the toggle knob 211 of the discharging switch 20 along the open slot 151 toward the rear end, so that the gate section 24 is displaced and retracted along the guiding slot 19, therefore the discharging opening 14 is in an open state, which the user can swing the spreader left and right to throw out the material inside, so as to achieve the purpose of spreading. as shown in FIGS. 7 and 8, the discharging opening 14 of the main body 10 can be further assembled with a dispersion plate 101, the dispersion plate 101 is configured to evenly disperse the material, thereby improving the efficiency of the spreading operation. As shown in FIG. 9, the discharging opening 14 of the main body 10 can be assembled with an extension tube 102, so that the extension tube 102 is configured to increase the discharge distance, and further increase the distance and range of the material that can be spread.

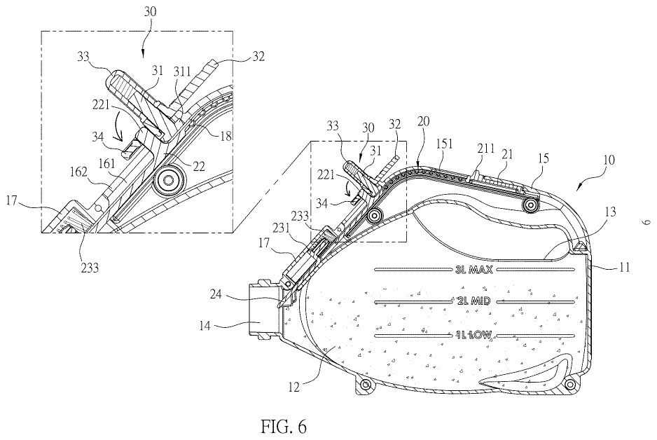

Secondly, as shown in FIGS. 5 and 6, when the gate section 24 is away from the discharging opening 14 to form an open state, the spring member 233 is squeezed by the raised plate 231 to form a compressed state. When the toggle knob 211 of the discharging switch 20 is released back, the gate section 24 is reset to block the discharging opening 14 due to the rebound of the spring member 233. Therefore, when the toggle knob 211 is pushed to the rear end along the open slot 151, the discharging switch 20 located at the positioning column 221 of the positioning section 22 abuts against the edge of the switching panel 32 of the locking unit 30 along the positioning slot 162. At this time, the user presses the fastening member 34 downward to make the engagement hole 343 to engage with the positioning column 221, thereby limiting the positioning of the discharging switch 20 so that the toggle knob 211 can be loosened without need for applying force to the toggle knob 211.

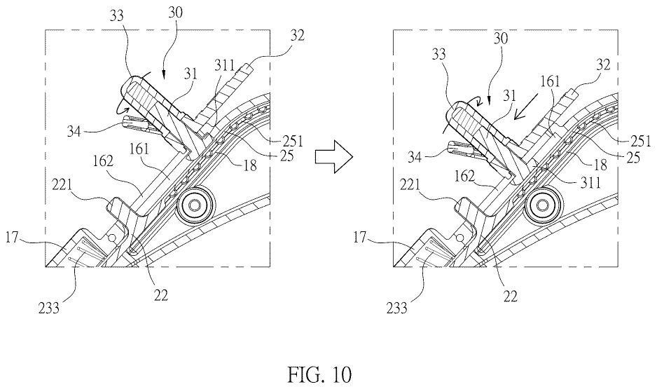

As shown in FIG. 10, the discharging switch 20 can be used in conjunction with the locking unit 30 to adjust the material discharging amount. First, the locking nut 33 is loosened, and the locking screw rod 31 is pushed by the switching panel 32 to adjust the displacement along the channel 161. The surface of the adjusting portion 16 is further provided with a plurality of scale marks 163, so that the locking unit 30 can be adjusted to any position on the adjusting portion 16 according to the discharging range and the type of material. After the adjustment, the locking nut 33 is tightened and fixed, so that the locking unit 30 is restricted in position. Thus, the displacement length of the positioning column 221 can be restricted by the locking unit 30, thereby controlling the blocking area of the gate section 24 between the discharging opening 14 and the storage space 12 to adjust the amount of spread material.

The structure of the above-mentioned specific embodiment can provide the following benefits: the overall structure of the handheld spreader of the invention is simple and easy to assemble, and the convenience of maintenance and cleaning is improved. The spreader is hand-held and swung to throw and spread the materials in the storage space 12 out of the discharging opening 14, which eliminates the weight and cost of the motor, so that each piece of land can evenly receive the spreading materials. The discharging switch 20 collocates with the opening and closing function of the locking unit 30, which not only frees the fingers from continuously pushing the toggle knob 211, making the structure more labor-saving to use. Also, the locking unit 30 is displaced and positioned on the adjusting portion 16, further limiting the displacement path of the discharging switch 20 and controlling the discharge amount.

Although the present invention has been explained in relation to its preferred embodiment, it is to be understood that many other possible modifications and variations can be made without departing from the spirit and scope of invention as hereinafter claimed.

What is claimed is:

1. A handheld spreader comprising a main body, a discharging switch and a locking unit; wherein
the main body is formed from two symmetrical cases and comprises a storage space, a feed opening connected to the storage space, a discharge opening, and a handle, wherein the handle is arranged above the feed opening, and the handle further downwardly has an adjusting portion and a spring groove in sequence toward the discharge opening; a track is disposed at an inner top surface between the handle and the adjusting portion, and an open slot is disposed on an upper surface of the handle and connected to the track; a guiding slot is disposed and connected between an end of the track and the discharge opening; the adjusting portion is convex and hollow with a channel connected to the track, and a positioning slot is disposed on the adjusting portion and having a width smaller than a width of the channel;
the discharging switch is disposed among the track, the guiding slot and the discharge opening, and is integrally formed to include an adjusting section, a positioning section, a spring section and a gate section in sequence; the adjusting section has a toggle knob and is limited in the open slot; the positioning section has a positioning column protruding out of the positioning slot; the spring section is provided with a raised plate with a protruding pillar facing the positioning column, and the protruding pillar is jacketed with a spring member and is arranged in the spring groove; the gate section is normally closed between the discharging opening and the storage space; and
the locking unit is installed on the adjusting portion and includes a locking screw rod, a switching panel, a locking nut and a fastening member; a slidable plate is formed at a bottom end of the locking screw rod and is slidably accommodated in the channel; the locking screw rod is positioned to pass through the positioning slot, a through aperture is disposed on one end of the switching panel through an upper and lower surfaces, the switching panel passes through the locking screw rod through the through aperture, and two shaft apertures are disposed on opposite sides of the switching panel; the locking nut and the locking screw rod are screwed together to further tighten the locking screw rod and the switching panel onto the positioning slot; the fastening member has two buckle arms, a convex shaft is mounted inside the two buckle arms and assembled to each of the shaft aperture on opposite sides of the switching panel, so that the fastening member is rotatably assembled on the switching panel; and the fastening member is further provided with a fastening hole between the two buckle arms, the fastening hole used to engage with the positioning column of the discharging switch.

2. The handheld spreader as claimed in claim 1, wherein a curved section is formed between the adjusting section and the positioning section of the discharging switch to correspondingly match the track to form a curved path between the handle and the adjusting portion.

3. The handheld spreader as claimed in claim 1, wherein a bottom face of the curved section has a plurality of parallel transverse grooves.

4. The handheld spreader as claimed in claim 1, wherein an area of the gate section of the discharging switch is larger than an area of the spring section.

5. The handheld spreader as claimed in claim 1, wherein the discharge opening of the main body is configured to be equipped with a discharging plate.

6. The handheld spreader as claimed in claim 1, wherein the discharge opening of the main body is configured to be equipped with an extension tube.
